(19) United States
(12) Patent Application Publication
(10) Pub. No.: US 2006/0218584 A1
(43) Pub. Date: Sep. 28, 2006

(54) FILTERING ELECTRONIC PROGRAM GUIDES BASED ON CHANNEL ACCESSIBILITY

(75) Inventor: John Taylor Gildred, Oakland, CA (US)

Correspondence Address: DVA/PIONEER RESEARCH CENTER USA, INC., 2265 E. 220TH STREET, LONG BEACH, CA, 90810, US

(73) Assignee: PIONEER RESEARCH CENTER, USA, INC., San Jose, CA (US)

(21) Appl. No.: 10/906,716

(22) Filed: Mar. 3, 2005

(51) Int. Cl. H04N 5/445; G06F 13/00; G06F 3/00

(52) U.S. Cl. 725/39

(57) ABSTRACT

A method of filtering an electronic program guide (EPG) information is disclosed. EPG information is retrieved from an EPG provider. The EPG information is filtered to retain program information related to programs delivered by a content delivery provider to a subscriber. The content delivery provider is different from the EPG provider.

### BACKGROUND

1. Field of the Invention

Embodiments of the invention relate to the field of broadcasting, and more specifically, to electronic program guides (EPG).

2. Description of Related Art

Electronic Program Guides (EPGs) have become popular thanks to the proliferation of broadcasting technologies. A wide range of programs can now be broadcast to viewers through cable television, direct satellite systems, or digital networks. With the EPG, viewers can now browse through the scheduled programs, select programs for viewing or recording, and perform many complex operations regarding viewing the delivered contents.

However, as the amount of programs increases, the information content of the EPG increases as well. Often, a viewer is faced with a vast amount of program information with complex navigation patterns. When only a small number of channels are subscribed by a viewer, the program information of other non-subscribed channels may cause wasted time, confusion, and sometimes annoyance.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating a computer system in which one embodiment of the invention can be practiced.

FIG. 1B is a diagram illustrating a system in which one embodiment of the invention can be practiced.

FIG. 2 is a flowchart illustrating a process-to-process EPG information according to one embodiment of the invention.

FIG. 3 is a flowchart illustrating a process to filter the EPG information according to one embodiment of the invention.

FIG. 4 is a flowchart illustrating a process to obtain channel accessibility according to one embodiment of the invention.

FIG. 5 is a flowchart illustrating a process to remove the EPG information according to one embodiment of the invention.

FIG. 6 is a diagram illustrating an extracting/filtering system in which one embodiment of the invention can be practiced.

### DESCRIPTION OF THE INVENTION

One embodiment of the invention is a technique to filter electronic program guide (EPG) information. EPG information is retrieved from an EPG provider. The EPG information is filtered to retain program information related to programs delivered by a content delivery provider to a subscriber. The content delivery provider is different from the EPG provider.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, software, firmware, microcode, or any combination thereof. When implemented in software, firmware, or microcode, the elements of the embodiment of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the machine accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

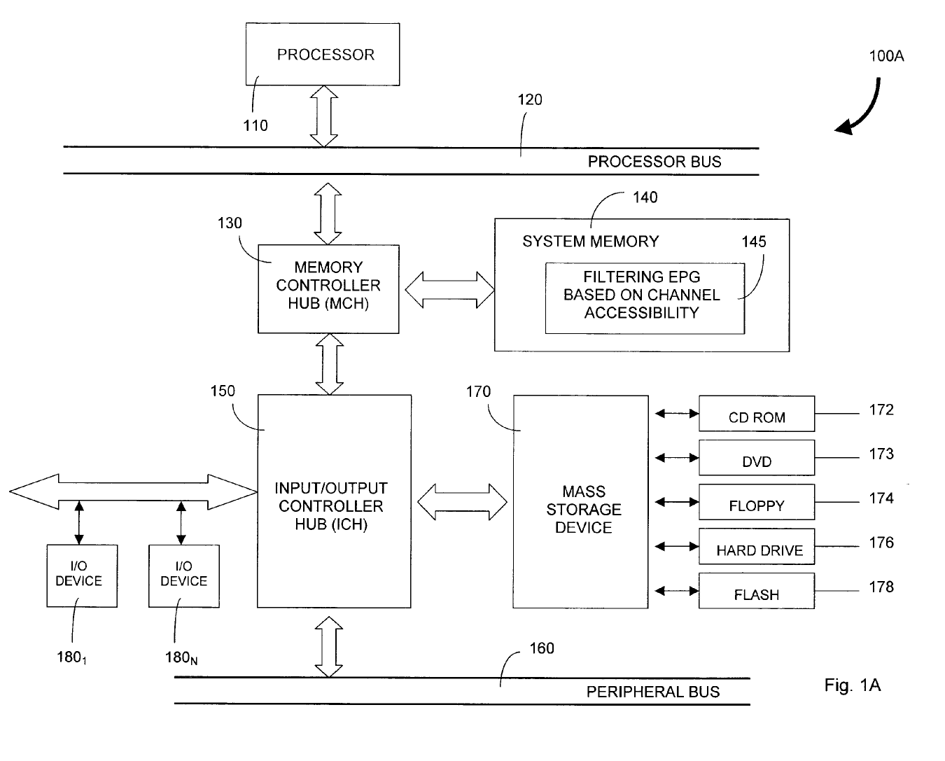

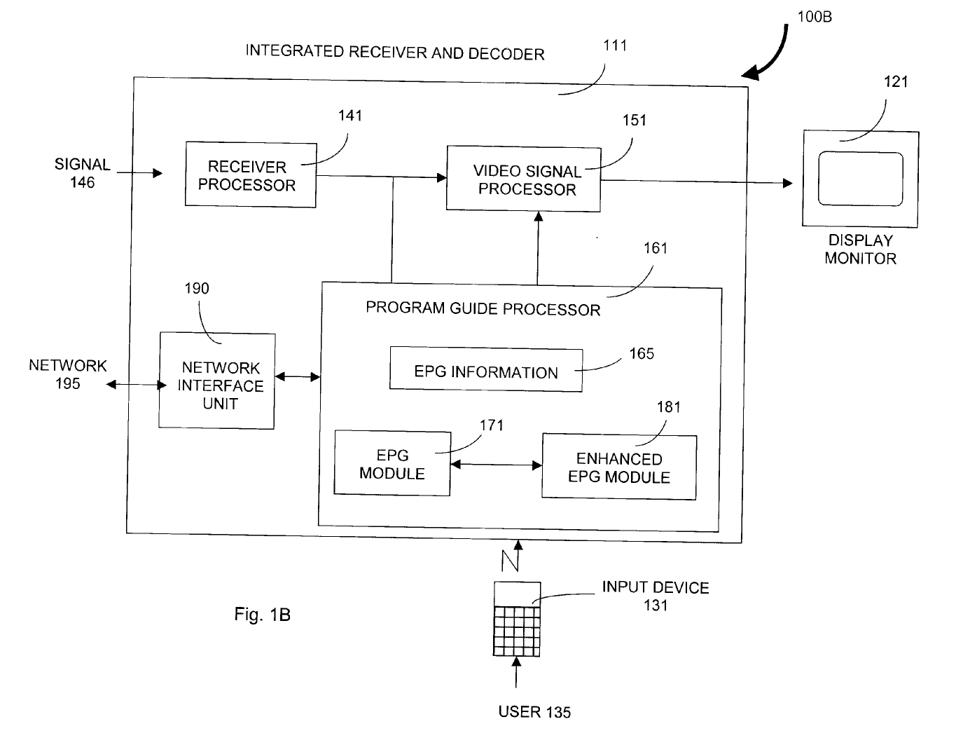

FIG. 1A is a diagram illustrating a processor system 100A in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, super scalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management 145 (i.e., intelligent recording of a scheduled program). Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described in the following. The term “data” here refers to any type of information that is encoded for machine-readable purposes. Therefore, it may include program, code, data, file, etc.

FIG. 1B is a diagram illustrating a system 100B in which one embodiment of the invention can be practiced. The system 100B includes an integrated receiver and decoder (IRD) 111, a display monitor 121, and an input device 131.

The IRD 111 may be unit separated from the display monitor or a part of a set-top box. It receives program signal 146 and interacts with a network 195. It includes a receiver processor 141, a video signal processor 151, a program guide processor 161, and a network interface unit 190. The receiver processor 141 performs signal processing to receive the program signal 146. The program signal 146 may be a video signal, a television signal, a radio frequency (RF) signal, a cable signal, or a signal received from a satellite. The receiver processor 141 includes appropriate circuitry to process the program signal 146 such as tuner, intermediate frequency (IF) processor, demodulator, decoder, picture-in-picture processor, etc. The video signal processor 151 performs video signal processing (e.g., luma and chroma processing) to generate video signal to be displayed on the display monitor 121. The video signal processor 151 also interfaces with the program guide processor 161 to receive the on-screen display (OSD) information such as the EPG graphical user interface (GUI).

The program guide processor 161 processes electronic program guide (EPG) information. It includes an EPG module 171, and enhanced EPG module 181, and EPG information 165. It contains a processor having memory that contains program code to execute instructions or programs that carry out the operations as described in the following. The program code may be embodied in a machine-readable medium such as memory, mass storage device, etc. as described above.

The EPG module 171 contains the EPG information 165 provided by an EPG provider. The EPG information 165 includes program identification information such as program title, start time, end time, topic, theme, actors, producers, director, description, and other relevant information for a particular channel. The enhanced EPG module 181 filters the EPG information to retain program information of programs delivered by a content delivery provider to a subscriber. The content delivery provider is different from the EPG provider. It may be any one of a television network, a cable operator, a direct satellite program provider, a digital cable content provider, and a network content provider. The user, therefore, views only the program information of the channels that the subscriber has access to.

The display monitor 121 is any display device that displays the received program. It may be a television set, an analog or digital display, a flat panel display, a liquid crystal display, a cathode ray tube (CRT), etc. It may be integrated into a computer system.

The input device 131 allows a user 135 to interact with the recorder 111. It may have a keyboard, an infrared transmitter/receiver, a wireless transmitter/receiver, etc. It may be connected to the IRD 111 or the display monitor 121 in a wired or wireless connectivity. The user 135 uses the input device 131 to view the filtered EPG. The IRD 111 provides graphical user interface (GUI) to allow the user to select programs, channels, program schedules, program contents, etc.

The network interface unit 190 provides interface to the network 195 (e.g., Internet) to allow receiving and/or transmitting network information such as e-mail, account information, subscription information, administrative information, etc.

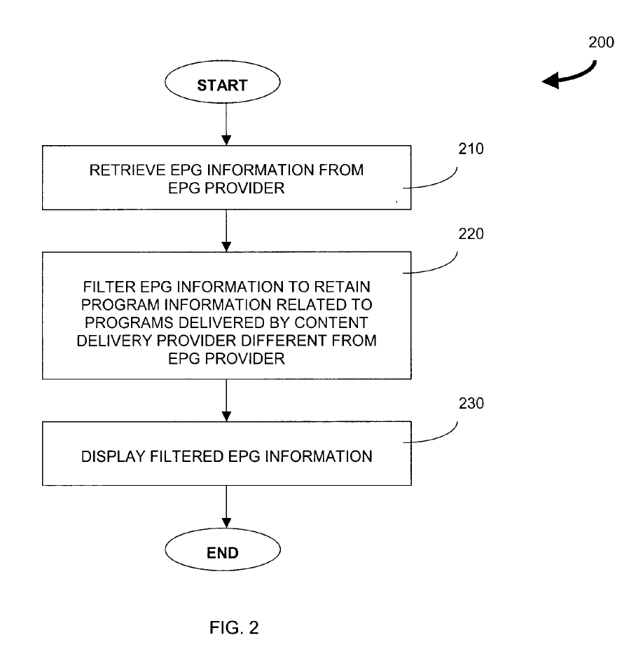

FIG. 2 is a flowchart illustrating a process 200 to process EPG information according to one embodiment of the invention. The process 200 is performed by the enhanced EPG module 181 shown in FIG. 1B.

Upon START, the process 200 retrieves the EPG information from the EPG provider (Block 210). The EPG provider is a provider of the EPG for a wide variety of broadcast channels including those channels that are accessible to the subscriber. Next, the process 200 filters the EPG information to retain the program information related to the programs delivered by the content delivery provider (Block 220). The content delivery provider is different than the EPG provider. Next, the process 200 displays the filtered EPG information on the display (Block 230) and is then terminated. The filtered EPG information includes only the program information related to the programs provided by the content delivery provider.

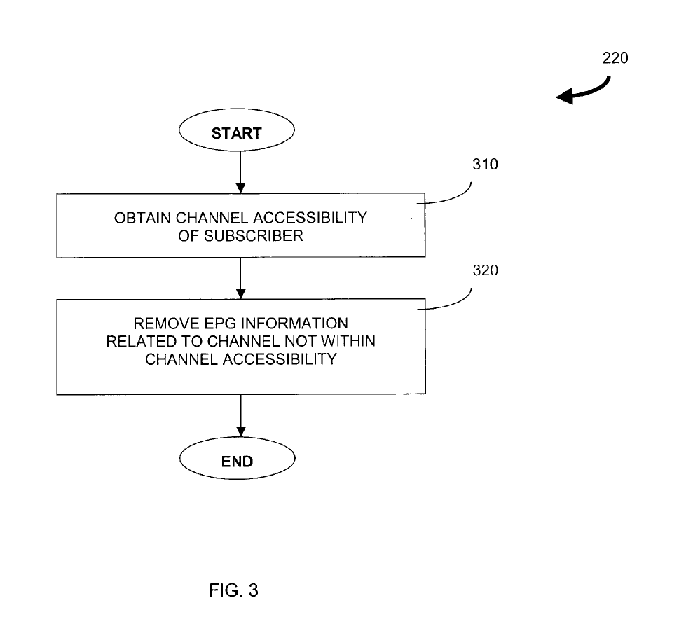

FIG. 3 is a flowchart illustrating a process 220 to filter the EPG information according to one embodiment of the invention.

Upon START, the process 220 obtains the channel accessibility of the subscriber (Block 310). The channel accessibility provides information on the channels that the subscriber is allowed to view according to the subscriber's subscription to the services provided by the content delivery provider. Next, the process 220 removes the EPG information related to the channel that is not within the channel accessibility (Block 320) and is then terminated.

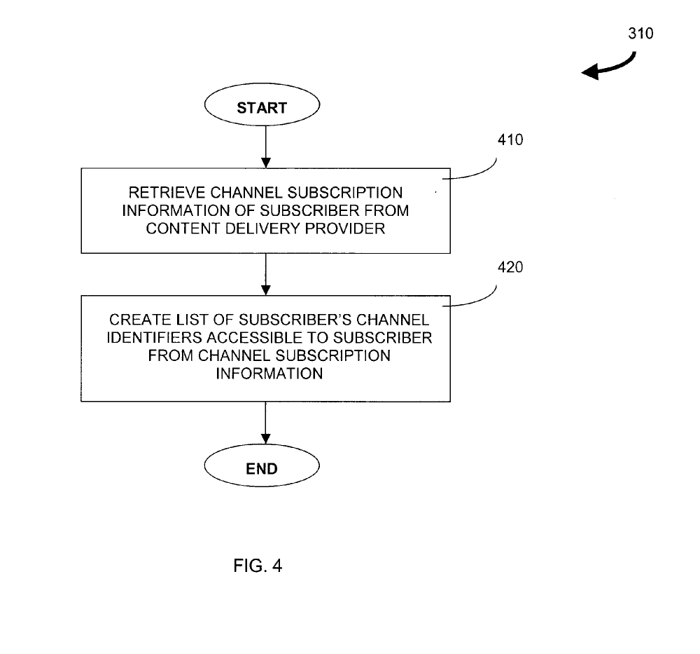

FIG. 4 is a flowchart illustrating a process 310 to obtain channel accessibility according to one embodiment of the invention.

Upon START, the process 310 retrieves the channel subscription information of the subscriber from the content delivery provider (Block 410). The subscription information may be available internally to the integrated receiver and decoder when it is installed or when the subscriber first subscribed to the services. It may also be retrieved on demand through the service channel or through the network interface unit.

Next, the process 310 creates a list of subscriber's channel identifiers accessible to the subscriber form the channel subscription information (Block 420) and is then terminated. The channel identifiers are the names of the channels that provide the content or programs. The channel identifiers may be local numbers (e.g., channels 77, 82) or the global names (e.g., CNN, ESPN, HBO, MTV).

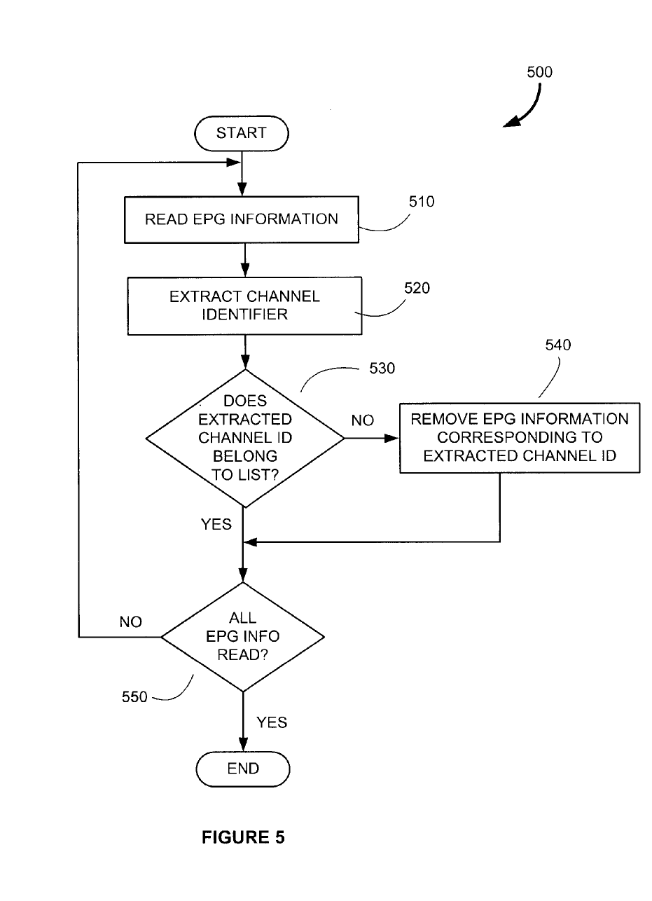

FIG. 5 is a flowchart illustrating a process 320 to remove the EPG information according to one embodiment of the invention.

Upon START, the process 320 reads the EPG information (Block 510). The EPG information may be arranged in a specified format. Next, the process 320 extracts a channel identifier from the EPG information (Block 520). This can be done by obtaining the value in a specified field designated for the channel identifier.

Then, the process 320 determines if the extracted channel identifier belongs to the list of subscriber's accessible channel identifiers (Block 530). If not, the process 320 removes the EPG information corresponding to the extracted channel identifier (Block 540) and proceeds to Block 550. Otherwise the process 320 determines if the entire EPG information has been read (Block 550). If not, the process 320 returns to Block 510 to continue reading the EPG information. Otherwise, the entire EPG information has been filtered and the process 320 is terminated.

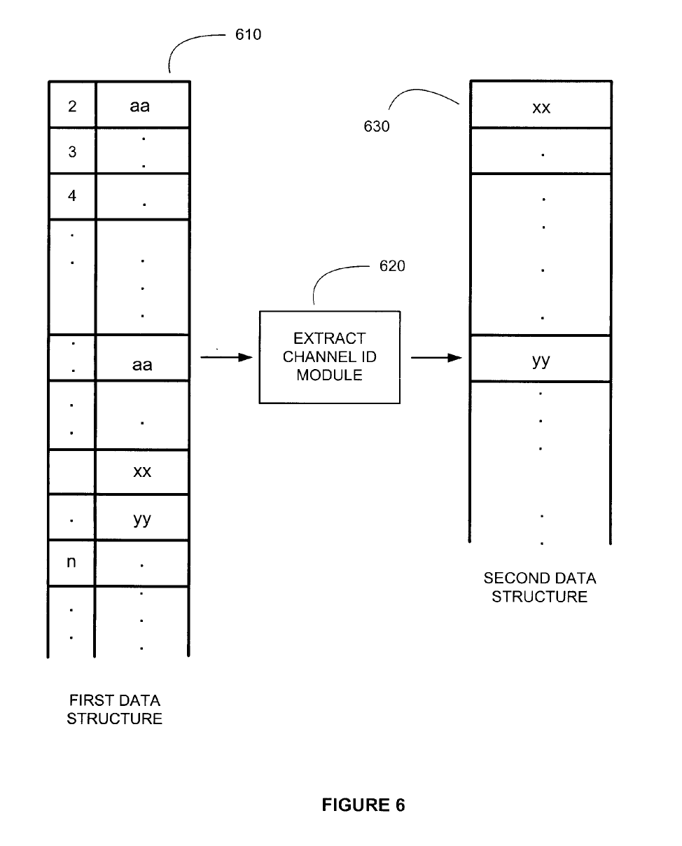

FIG. 6 is a diagram illustrating an extracting/filtering system in which one embodiment of the invention can be practiced. The system includes a first data structure 610, an extract channel ID module 620 and a second data structure 630. The extract channel ID module 620 extracts data (i.e., the channel IDs) from the first data structure 610 and stores the data in the second data structure 630. The data stored in the second data structure 630 may be the channel ID of a subscribed channel. The data in the second data structure 630 may be updated periodically. New data is stored and/or old data is deleted from the second data structure 630 if there is a change in a subscriber list. The subscriber list may list the channels that a subscriber has ordered. It is contemplated that the extract module may extract other data (i.e., channel number, network name, etc.).

In one embodiment of the present invention, the PVR (Personal Video Recorder) uses multiple tuners. Each of the tuners is normally associated with one encoder and one cache, which may be a fixed or variable size cache (for a live signal) or a fixed file in the case where the incoming signal is merely transferred to the storage device.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
retrieving electronic program guide (EPG) information from an EPG provider; and
filtering the EPG information to retain program information related to programs delivered by a content delivery provider to a subscriber, the content delivery provider being different from the EPG provider.

2. The method of claim 1 further comprising:
displaying the filtered EPG information.

3. The method of claim 1 wherein filtering comprises:
obtaining channel accessibility of the subscriber; and
removing EPG information related to a channel that is not within the channel accessibility of the subscriber.

4. The method of claim 3 wherein obtaining comprises:
retrieving channel subscription information of the subscriber from the content delivery provider; and
creating a list of subscriber's channel identifiers of channels accessible to the subscriber from the channel subscription information.

5. The method of claim 3 wherein removing comprises:
reading the EPG information;
extracting a channel identifier from the EPG information; and
removing the EPG information corresponding to the extracted channel identifier if the extracted channel identifier does not belong to the list of the subscriber's channel identifiers.

6. The method of claim 1 wherein the programs are delivered by one of a television network, a cable operator, a direct satellite program provider, a digital cable content provider, and a network content provider.

7. An article of manufacture comprising:
a machine-accessible medium including data that, when accessed by a machine, causes the machine to perform operations comprising:
retrieving electronic program guide (EPG) information from an EPG provider; and
filtering the EPG information to retain program information related to programs delivered by a content delivery provider to a subscriber, the content delivery provider being different from the EPG provider.

8. The article of manufacture of claim 7 wherein the data further comprises data that, when accessed by the machine, causes the machine to perform operations comprising:
displaying the filtered EPG information.

9. The article of manufacture of claim 7 wherein the data causing the machine to perform filtering comprises data that, when accessed by the machine, causes the machine to perform operations comprising:
obtaining channel accessibility of the subscriber; and
removing EPG information related to a channel that is not within the channel accessibility of the subscriber.

10. The article of manufacture of claim 9 wherein the data causing the machine to perform obtaining comprises data that, when accessed by the machine, causes the machine to perform operations comprising:
retrieving channel subscription information of the subscriber from the content delivery provider; and
creating a list of subscriber's channel identifiers of channels accessible to the subscriber from the channel subscription information.

11. The article of manufacture of claim 9 wherein the data causing the machine to perform removing comprises data that, when accessed by the machine, causes the machine to perform operations comprising:
reading the EPG information;
extracting a channel identifier from the EPG information; and
removing the EPG information corresponding to the extracted channel identifier if the extracted channel identifier does not belong to the list of the subscriber's channel identifiers.

12. The article of manufacture of claim 7 wherein the programs are delivered by one of a television network, a cable operator, a direct satellite program provider, a digital cable content provider, and a network content provider.

13. A program guide module comprising:
an electronic program guide (EPG) module to store EPG information from an EPG provider; and
an enhanced EPG module coupled to the EPG module, the enhanced EPG module comprising:
a module to retrieve the EPG information from the EPG module, and
a module to filter the EPG information to retain program information related to programs delivered by a content delivery provider to a subscriber, the content delivery provider being different from the EPG provider.

14. The program guide module of claim 13 wherein the enhanced EPG module further comprises:
a module to display the filtered EPG information.

15. The program guide module of claim 13 wherein the module to filter comprises:
a module to obtain channel accessibility of the subscriber; and
a module to remove EPG information related to a channel that is not within the channel accessibility of the subscriber.

16. The program guide module of claim 15 wherein the module to obtain comprises:
a module to retrieve channel subscription information of the subscriber from the content delivery provider; and
a module to create a list of subscriber's channel identifiers of channels accessible to the subscriber from the channel subscription information.

17. The program guide module of claim 15 wherein the module to remove comprises:
a module to read the EPG information;
a module to extract a channel identifier from the EPG information; and
a module to remove the EPG information corresponding to the extracted channel identifier if the extracted channel identifier does not belong to the list of the subscriber's channel identifiers.

18. The program guide module of claim 13 wherein the programs are delivered by one of a television network, a cable operator, a direct satellite program provider, a digital cable content provider, and a network content provider.
